(19) United States
(12) Patent Application Publication
(10) Pub. No.: US 2026/0368686 A1
(43) Pub. Date: Nov. 19, 2026

(54) MANAGEMENT SYSTEM, MANAGEMENT METHOD, AND RECORDING MEDIUM

(71) Applicant: NEC Corporation, Tokyo (JP)

(72) Inventor: Takuro KAGOSHIMA, Tokyo (JP)

(73) Assignee: NEC Corporation, Tokyo (JP)

(21) Appl. No.: 19/148,381

(22) PCT Filed: Jan. 20, 2023
(86) PCT No.: PCT/JP2023/001751

§ 371 Date: Jul. 16, 2025

(51) Int. Cl. G06Q 10/083; G01C 21/36

(52) U.S. Cl. CPC G06Q 10/08355; G01C 21/3676

(57) ABSTRACT

A management system according to an aspect of the present disclosure includes: at least one memory storing instructions; and at least one processor configured to execute the instructions to: acquire a position of a candidate planned route point for collecting road information, a position of a delivery destination of a delivery vehicle on which a sensor that collects the road information is mounted, and a delivery time limit to the delivery destination; determine whether the delivery vehicle passes through the candidate planned route point while delivering within the delivery time limit based on the position of the candidate planned route point, the position of the delivery destination, and the delivery time limit; and display on a terminal used by a driver of the delivery vehicle to display information regarding the candidate planned route point where it is determined that the delivery vehicle passes.

### TECHNICAL FIELD

The present disclosure relates to a management system that manages collection of road information, and the like.

### BACKGROUND ART

Various sensors are mounted on a vehicle to collect information on a road while the vehicle is traveling. For example, a video of a drive recorder mounted on the vehicle is analyzed to collect information on deterioration such as a crack, a pot hole, and rutting occurring on a road surface. PTL 1 discloses collecting a route position of a road, the number of lanes, a sign, and the like from a video of an in-vehicle camera device. In PTL 1, a video of the in-vehicle camera device mounted on a taxi is used.

### CITATION LIST

### Patent Literature

PTL 1: JP 2009-075858 A1

### SUMMARY OF INVENTION

### Technical Problem

If a sensor is mounted on a delivery vehicle that delivers baggage, information on a road on which the delivery vehicle travels for delivery can be collected. However, if the delivery vehicle makes a detour to collect road information, the delivery may be delayed.

An object of the present disclosure is to provide a management device or the like that can support collection of road information of more points while achieving timely delivery.

### Solution to Problem

A management system according to the present disclosure includes: acquisition means for acquiring a position of a candidate planned route point for collecting road information, a position of a delivery destination of a delivery vehicle on which a sensor that collects the road information is mounted, and a delivery time limit to the delivery destination; determination means for determining whether the delivery vehicle passes through the candidate planned route point while delivering within the delivery time limit based on the position of the candidate planned route point, the position of the delivery destination, and the delivery time limit; and display control means for causing a terminal used by a driver of the delivery vehicle to display information regarding the candidate planned route point where it is determined that the delivery vehicle passes.

A management method according to the present disclosure includes: acquiring a position of a candidate planned route point for collecting road information, a position of a delivery destination of a delivery vehicle on which a sensor that collects the road information is mounted, and a delivery time limit to the delivery destination; determining whether the delivery vehicle passes through the candidate planned route point while delivering within the delivery time limit based on the position of the candidate planned route point, the position of the delivery destination, and the delivery time limit; and causing a terminal used by a driver of the delivery vehicle to display information regarding the candidate planned route point where it is determined that the delivery vehicle passes.

A program according to the present disclosure includes: acquiring a position of a candidate planned route point for collecting road information, a position of a delivery destination of a delivery vehicle on which a sensor that collects the road information is mounted, and a delivery time limit to the delivery destination; determining whether the delivery vehicle passes through the candidate planned route point while delivering within the delivery time limit based on the position of the candidate planned route point, the position of the delivery destination, and the delivery time limit; and causing a terminal used by a driver of the delivery vehicle to display information regarding the candidate planned route point where it is determined that the delivery vehicle passes. The program may be stored in a non-transitory recording medium which can be computer-readable.

### Advantageous Effects of Invention

According to the present disclosure, it is possible to support collection of the road information of more points while achieving timely delivery.

### BRIEF DESCRIPTION OF DRAWINGS

FIG. 1 is a diagram illustrating an example of a company related to an example embodiment.

FIG. 2 is a diagram illustrating an example of an apparatus used in the example embodiment.

FIG. 3 is a block diagram illustrating a configuration example of a management system according to a first example embodiment.

FIG. 4 is a diagram illustrating an example of a position of a candidate planned route point.

FIG. 5 is a diagram illustrating an example of a position of a delivery destination.

FIG. 6 is a diagram illustrating an example of a delivery time limit.

FIG. 7A is a diagram illustrating an example of a route for traveling through the candidate planned route point.

FIG. 7B is a diagram illustrating the example of the route for traveling through the candidate planned route point.

FIG. 8 is a flowchart illustrating an operation example of the management system according to the first example embodiment.

FIG. 9 is a block diagram illustrating a configuration example of a management system according to a second example embodiment.

FIG. 10 is a flowchart illustrating an operation example of the management system according to the second example embodiment.

FIG. 11 is a block diagram illustrating an example of a hardware configuration of a computer.

### EXAMPLE EMBODIMENTS

### First Example Embodiment

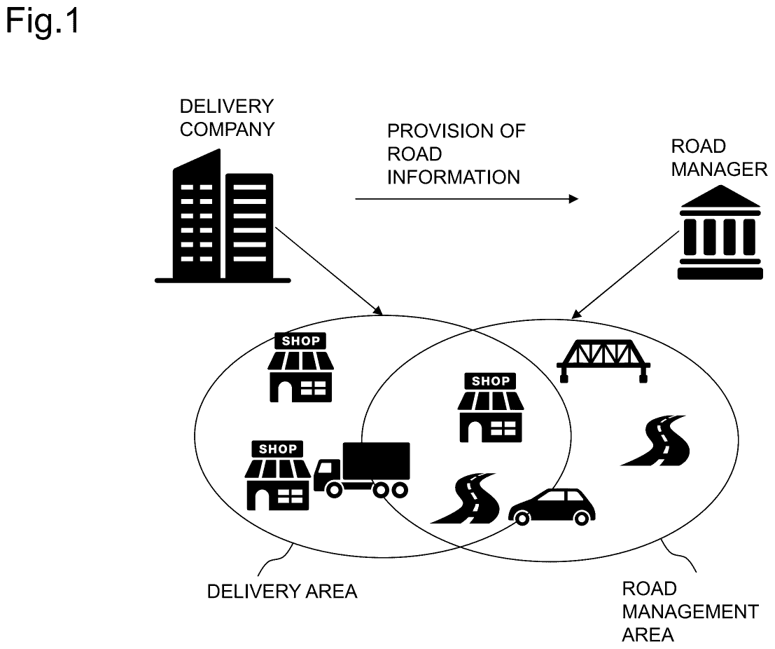

FIG. 1 is a diagram illustrating an example of a company related to the present example embodiment. FIG. 1 illustrates a road manager and a delivery company. The road manager travels a vehicle equipped with a sensor to collect road information. Then, the road manager plans maintenance of a road based on the road information. As illustrated in FIG. 1, the road manager controls roads in a predetermined range of a road management area. Next, the delivery company delivers baggage to a delivery destination. As illustrated in FIG. 1, one delivery vehicle of the delivery company may control a predetermined delivery area including a plurality of stores.

The delivery area of the delivery vehicle and the road management area may overlap or be close in distance. Therefore, the cost for collecting the road information can be reduced by the delivery vehicle collecting the road information. Hereinafter, a management system 100 that assists the road manager to collect the road information by causing the delivery vehicle of the delivery company to travel instead of traveling the vehicle will be described.

Application of the management system 100 according to the present disclosure is not limited to collection of the road information using the delivery vehicle that performs delivery to a store. The management system 100 is also applicable to cases of using the delivery vehicle that delivers baggage to a home and the delivery vehicle that transports baggage between warehouses. A length of a distance by which the delivery vehicle performs delivery is not particularly limited.

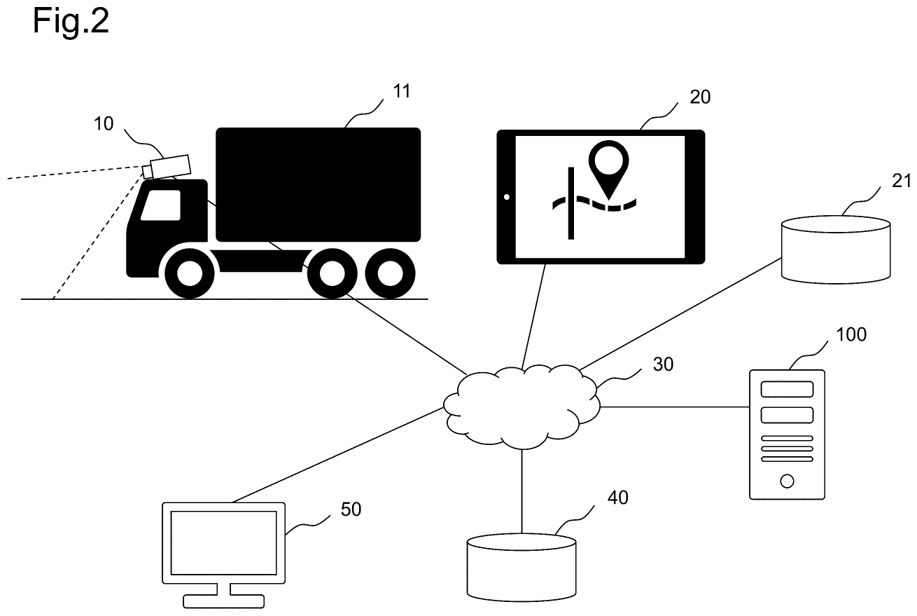

FIG. 2 is a diagram illustrating an example of an apparatus used in the present example embodiment. In the present example embodiment, a sensor 10, a driver terminal 20, a delivery management database 21, a road information database 40, and a road manager terminal 50 are used. The management system 100 is connected to the driver terminal 20 and the delivery management database 21 via a communication network 30. The management system 100 may be connected to the sensor 10, the road information database 40, and the road manager terminal 50 as necessary.

The sensor 10 is a sensor that can be mounted on a vehicle and can collect the road information on a road on which the vehicle travels. The road information collected by the sensor 10 is stored in the road information database 40.

The sensor 10 is mounted on a delivery vehicle 11. The delivery vehicle 11 is in charge of delivery to an area within or near the road management area of the road manager. The sensor 10 may continue to collect the road information while the delivery vehicle 11 is delivering. The road is periodically collected by periodically traveling through an area which the delivery vehicle is in charge of. Alternatively, the sensor 10 may collect the road information only while the delivery vehicle 11 travels through a candidate planned route point to be described later.

The sensor 10 is, for example, a camera that captures a road image including a road or an environment around the road. The road image is an example of the road information. The sensor 10 as described above is achieved by, for example, a drive recorder. The road image captured by the sensor 10 may be a still image or a moving image captured while the delivery vehicle 11 moves. The road image may be automatically captured at any intervals. However, the type of the sensor 10 is not limited to the drive recorder, and may be a sensor or a three-dimensional camera that measures unevenness of a road surface or an object around the road. For example, a millimeter wave radar that detects millimeter wave information, LiDAR (Laser Imaging Detection and Ranging) that acquires a distance to an object, or a stereo camera that captures a peripheral image is used as the sensor 10.

A mounting position of the sensor 10 on the delivery vehicle 11 is not particularly limited. In FIG. 2, one sensor 10 and one delivery vehicle 11 are illustrated. However, a plurality of the delivery vehicles 11 each equipped with the sensor 10 may be prepared. Each of the delivery vehicles 11 may be provided with a plurality of the sensors 10. The plurality of sensors 10 may be capable of collecting different types of road information.

The driver terminal 20 is a terminal used by a driver who drives the delivery vehicle 11. The driver terminal 20 displays information to the driver. The driver terminal 20 is, for example, a personal computer, a smartphone, a tablet, a car navigation device, or the like.

The delivery management database 21 stores data related to delivery of baggage. For example, the delivery management database 21 stores a delivery destination position and a delivery time limit to each delivery destination. The delivery destination position is, for example, an address of a delivery destination store. The delivery time limit to the delivery destination is appropriately determined, for example, a deadline time by which the delivery vehicle 11 arrives at the delivery destination or a deadline time until unloading is completed.

The delivery management database 21 may further store a quantity of baggage, delivery schedule information, and delivery status of each delivery destination. The delivery schedule information may include a scheduled route to the delivery destination and a scheduled delivery time to the delivery destination in addition to the order of scheduled delivery to the delivery destination. The scheduled delivery time may be a scheduled time of arrival at the delivery destination or a scheduled time of departure from the delivery destination. The delivery status is information indicating whether the delivery to each delivery destination has been completed or a delivery completion time of each delivery destination. A time point at which the delivery has been completed is appropriately determined.

The road information database 40 stores road information and position information of a point where the road information is collected in association with each other. The position information includes, for example, latitude and longitude, position information obtained by a global navigation satellite system (GNSS) or a global positioning system (GPS), or a position on a map. The position information may be acquired by any method, and the position information acquired by the sensor 10 may be stored.

The road manager terminal 50 is a terminal that displays information to the road manager. The road manager terminal 50 may display the road information stored in the road information database 40 or a result of analyzing the stored road information. For example, a state of the road surface obtained as a result of analyzing the road image is displayed. The state of the road surface includes, for example, a deterioration degree of the road surface such as a degree of a crack generated on the road surface. A route position, the number of lanes, and a recognition result of a sign may be displayed as the analysis result.

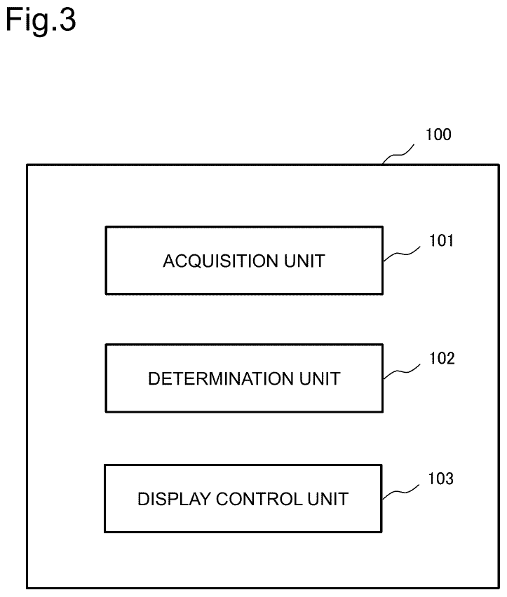

FIG. 3 is a block diagram illustrating a configuration example of the management system 100 according to the first example embodiment. The management system 100 includes an acquisition unit 101, a propriety determination unit 102, and a display control unit 103.

The acquisition unit 101 acquires a position of a candidate planned route point. In addition, the acquisition unit 101 acquires the delivery destination position of the delivery vehicle 11 and the delivery time limit to the delivery destination.

The candidate planned route point is a candidate of a point where the delivery vehicle 11 equipped with the sensor 10 travels to collect the road information. For example, a point with insufficient road information is determined as the candidate planned route point. In addition, a point where the delivery vehicle 11 does not usually pass at the time of delivery can be designated as the candidate planned route point.

The candidate planned route point may be stored in advance in the road information database 40. In this case, the acquisition unit 101 acquires the position of the candidate planned route point from the road information database 40. The candidate planned route point may be determined automatically or may be determined manually by the road manager. The candidate planned route point may be a point designated by a specific latitude or longitude or a region having a certain size. The candidate planned route point can be designated by a predetermined road management unit. For example, the candidate planned route point may be designated for each region obtained by dividing the map by a predetermined range. The candidate planned route point may be designated by an interval unit obtained by dividing a route of the road by a predetermined length. The candidate planned route point may be designated by a name of the road.

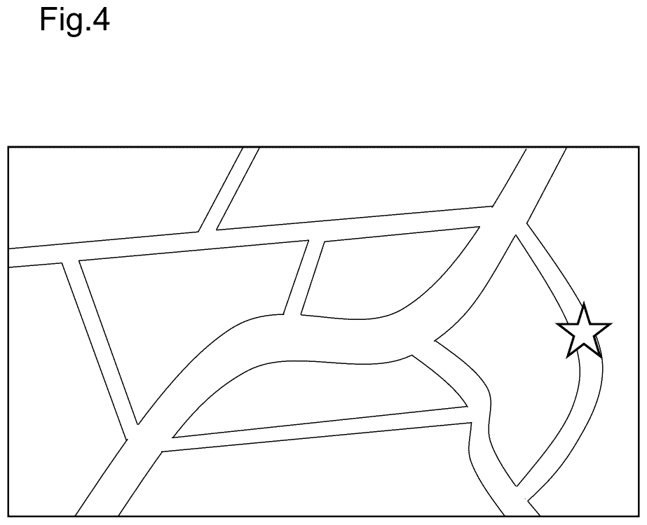

FIG. 4 is a diagram illustrating an example of the position of the candidate planned route point acquired by the acquisition unit 101. For example, a position of a point indicated by a star sign in FIG. 4 can be acquired as the position of the candidate planned route point.

For example, the acquisition unit 101 acquires the delivery destination position and the delivery time limit to the delivery destination from the delivery management database 21. In addition, the acquisition unit 101 may acquire other information including the delivery schedule information from the delivery management database 21.

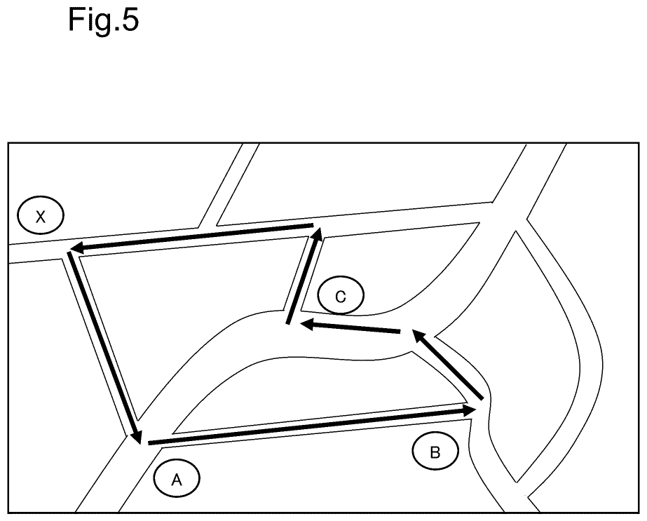

FIG. 5 is a diagram illustrating an example of the delivery destination position acquired by the acquisition unit 101. In FIG. 5, positions of three stores (stores A, B, and C) which are delivery destinations of the delivery vehicle 11 are illustrated on the map. Further, FIG. 5 illustrates a position of a delivery center X. Furthermore, FIG. 5 illustrates an example of the delivery schedule information stored in the delivery management database 21. According to the delivery schedule information, for example, the delivery vehicle 11 starts from the delivery center X, visits the three stores, and returns to the delivery center X.

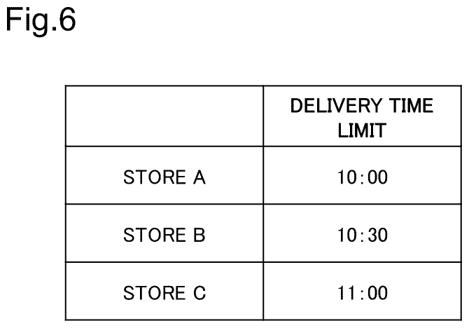

FIG. 6 is a diagram illustrating an example of the delivery time limit acquired by the acquisition unit 101. In FIG. 6, a deadline time by which the delivery vehicle delivers to the three stores is illustrated.

The propriety determination unit 102 determines whether the delivery vehicle 11 can pass through the candidate planned route point while delivering within the delivery time limit based on the position of the candidate planned route point, the position of the delivery destination, and the delivery time limit acquired by the acquisition unit 101. The determination method by the propriety determination unit 102 is not particularly limited as long as it is possible to predict whether the delivery arrives in time for the delivery time limit.

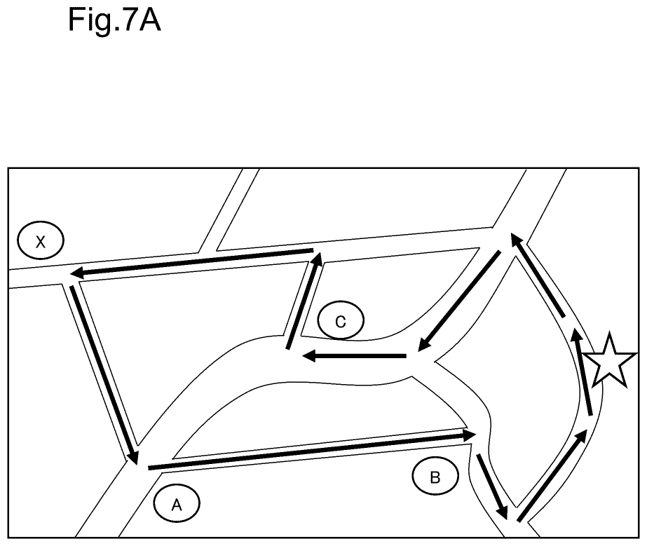

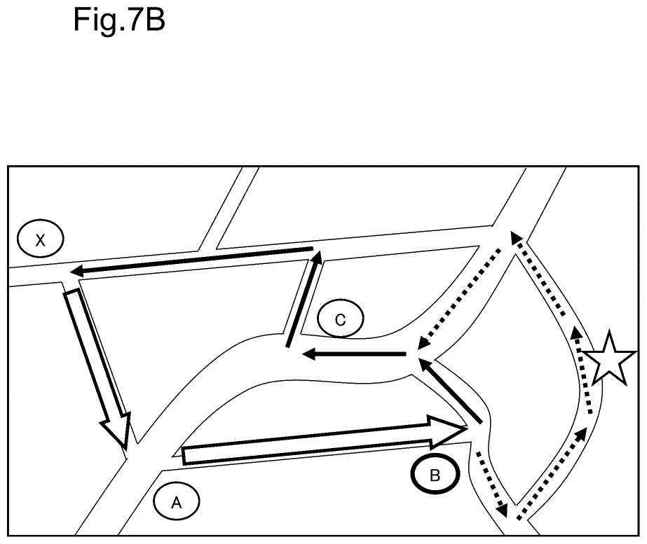

For the determination, the propriety determination unit 102 may determine a route for traveling through the candidate planned route point. A case where the propriety determination unit 102 makes a determination before the delivery vehicle 11 starts delivery will be described as an example. For example, the propriety determination unit 102 determines a route for traveling from a departure point to the candidate planned route point and the delivery destination. FIG. 7A is a diagram illustrating an example of a route for traveling through the candidate planned route point. The propriety determination unit 102 calculates a moving time required by the delivery vehicle 11 for the determined route. Thereafter, the propriety determination unit 102 calculates the scheduled delivery time to each delivery destination from the scheduled departure time of the departure point and the calculated moving time. In a case where the scheduled delivery time is earlier than the delivery time limit, the propriety determination unit 102 determines that the delivery vehicle 11 can pass through the candidate planned route point while delivering within the delivery time limit.

The propriety determination unit 102 may use the delivery schedule information acquired by the acquisition unit 101 in determining a route for traveling through the candidate planned route point. For example, the propriety determination unit 102 may determine whether it is possible to pass through the candidate planned route point on the way of making the rounds to the delivery destination in a scheduled order.

While the delivery vehicle 11 is delivering, the propriety determination unit 102 may determine whether the delivery vehicle 11 can pass through the candidate planned route point while delivering within the delivery time limit. For example, the propriety determination unit 102 acquires a current position of the delivery vehicle 11 from the sensor 10 or the driver terminal 20. Furthermore, the propriety determination unit 102 may estimate the current position of the delivery vehicle 11 based on of the delivery status. Then, in a case where the scheduled route is temporarily deviated from the current position of the delivery vehicle 11 and the delivery vehicle passes through the candidate planned route point, the propriety determination unit 102 may determine whether the delivery vehicle can pass through the candidate planned route point.

The propriety determination unit 102 may determine whether the delivery vehicle 11 can pass through the candidate planned route point while delivering within the delivery time limit based on a current delivery status of the delivery vehicle 11. For example, in a case where the candidate planned route point is passed from a current time, the propriety determination unit 102 may determine whether delivery to a remaining delivery destination can be made by the delivery time limit. By the determination by the propriety determination unit 102 based on the current delivery status, in a case where the delivery has been completed earlier than planned in advance, it is possible to determine that the delivery vehicle 11 can pass through the candidate planned route point through which the delivery vehicle usually cannot pass.

An example in which the propriety determination unit 102 makes a determination while the delivery vehicle 11 is delivering will be described. FIG. 7B is a diagram illustrating the example of the route for traveling through the candidate planned route point. For example, the route traveled by the delivery vehicle 11 is indicated by a void arrow. In addition, the route in a case of making the rounds to the delivery destination according to the delivery schedule information is indicated by a solid arrow. After the delivery vehicle 11 arrives at the store B, the propriety determination unit 102 determines a route indicated by a dotted arrow going to the next delivery destination via the candidate planned route point. In a case where the delivery arrives in time for the delivery time limit to the store C which is the next delivery destination, the propriety determination unit 102 determines that it is possible to pass through the candidate planned route point.

The propriety determination unit 102 may determine whether the delivery vehicle 11 can pass through the candidate planned route point while delivering within the delivery time limit based on the traffic condition. For example, the propriety determination unit 102 calculates the moving time of the determined route according to an expected traffic volume on that day. The propriety determination unit 102 may calculate the moving time according to a current traffic volume.

In the determination, the propriety determination unit 102 may use information on the quantity of baggage to be delivered to each delivery destination. For example, the number of baggage to be delivered to the store may be small depending on the day. When the number of baggage is small, the time required for unloading work from the delivery vehicle 11 is shortened. Therefore, the delivery vehicle 11 can head for the next delivery destination more quickly. At this time, the acquisition unit 101 acquires the number of baggage from the delivery management database 21. Then, the propriety determination unit 102 calculates the scheduled departure time of the delivery destination in consideration of a scheduled work time according to the number of baggage. In a case where the delivery vehicle 11 heads for the next delivery destination or planned route point at the scheduled departure time, the propriety determination unit 102 determines whether the delivery vehicle 11 can pass through the candidate planned route point while delivering within the delivery time limit.

The propriety determination unit 102 may determine whether a plurality of the candidate planned route points can be passed. For example, in a case where the delivery arrives in time for the delivery time limit even when the delivery vehicle passes through each of a plurality of candidate planned route points, the propriety determination unit 102 determines that the delivery vehicle can pass through the plurality of candidate planned route points. Alternatively, in a case where the delivery arrives in time for the delivery time limit if the driver selects and travels through some of the plurality of candidate planned route points, the propriety determination unit 102 may determine that the delivery vehicle can pass through the some candidate planned route points.

The display control unit 103 causes the driver terminal 20 to display information regarding the candidate planned route point determined by the propriety determination unit 102 that the delivery vehicle 11 can pass. The driver of the delivery vehicle 11 looks at the displayed information and determines to travel through the candidate planned route point. The information regarding the candidate planned route point may support the determination by the driver as to whether the delivery vehicle travels through the candidate planned route point.

The information regarding the candidate planned route point includes the position of the candidate planned route point. The position of the candidate planned route point is indicated by, for example, a position of the point on the map or the name of the road. For example, the display control unit 103 causes the driver terminal 20 to display the map illustrated in FIG. 4. In FIG. 4, the position of the candidate planned route point is indicated by a star-shaped icon. The driver of the delivery vehicle 11 determines whether to travel through the displayed candidate planned route point.

The information regarding the candidate planned route point may include a route for traveling through the candidate planned route point. For example, the display control unit 103 displays a route that passes through the candidate planned route point and the delivery destination and is in time for the delivery time limit. Furthermore, the information regarding the candidate planned route point may include a distance to the candidate planned route point, a moving time, or a scheduled delivery time when the vehicle travels through the candidate planned route point.

The display control unit 103 may also cause the driver terminal 20 to display the information on the candidate planned route point for the candidate planned route point determined by the propriety determination unit 102 that the delivery vehicle 11 cannot pass. For example, in the display control unit 103, the position of the candidate planned route point may be displayed regardless of whether the candidate planned route point can be passed. In the display control unit 103, a route for traveling through the candidate planned route point that can be passed may be displayed.

In a case where there is no candidate planned route point that can be passed, in the display control unit 103, a route to travel through the delivery destination without traveling through the candidate planned route point may be displayed.

A priority for collecting the road information may be set to the candidate planned route point. For example, the road information database 40 stores the priority determined in advance for each candidate planned route point. In this case, the display control unit 103 may display the priority for each candidate planned route point. The driver determines to travel preferentially through the candidate planned route point having a high priority.

In the display control unit 103, the traffic condition of the road may be displayed. At this time, the display control unit 103 acquires the traffic condition from a server that manages the traffic volume of the road and whether the road can be passed. By displaying the traffic condition, the driver can determine to travel through the candidate planned route point when the traffic volume is small.

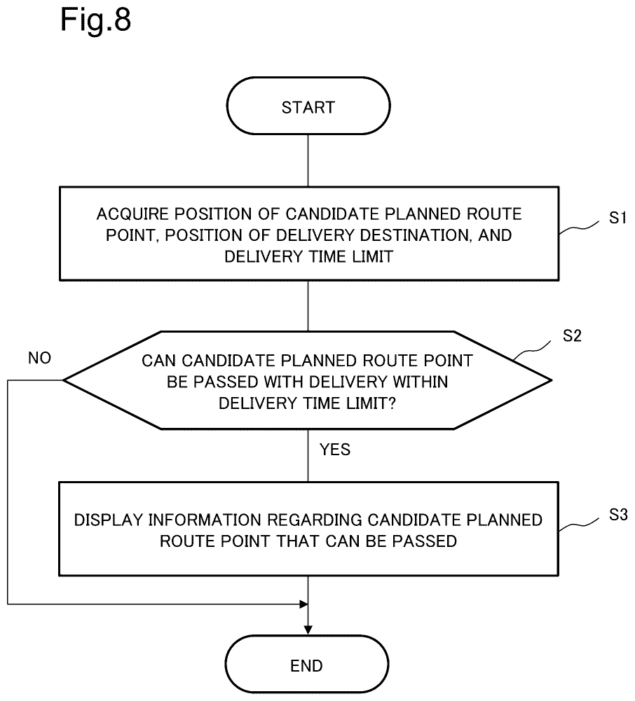

FIG. 8 is a flowchart illustrating an operation example of the management system 100 according to the first example embodiment. For example, the management system 100 may start the processing of FIG. 8 in response to the operation of the driver terminal 20 before the driver of the delivery vehicle 11 starts delivery.

The acquisition unit 101 acquires the position of the candidate planned route point for collecting the road information, the position of the delivery destination of the delivery vehicle 11, and the delivery time limit to the delivery destination (step S1). The propriety determination unit 102 determines whether the delivery vehicle 11 can pass through the candidate planned route point while delivering within the delivery time limit based on the position of the candidate planned route point, the position of the delivery destination, and the delivery time limit acquired by the acquisition unit 101 (step S2). When it is determined that the delivery vehicle can pass (step S2: Yes), the display control unit 103 causes the driver terminal 20 used by the driver of the delivery vehicle 11 to display the information regarding the candidate planned route point where it is determined that the delivery vehicle 11 can pass (step S3). When it is determined that the delivery vehicle cannot pass (step S2: No), in the display control unit 103, the information regarding the candidate planned route point is not displayed.

Thus, the management system 100 ends the processing of FIG. 8.

According to one example embodiment, the acquisition unit 101 acquires the position of the candidate planned route point for collecting the road information, the position of the delivery destination of the delivery vehicle 11, and the delivery time limit to the delivery destination. The propriety determination unit 102 determines whether the delivery vehicle 11 can pass through the candidate planned route point while delivering within the delivery time limit based on the position of the candidate planned route point, the position of the delivery destination, and the delivery time limit. In addition, the display control unit 103 causes the driver terminal 20 to display the information regarding the candidate planned route point determined that the delivery vehicle 11 can pass.

By displaying the information regarding the candidate planned route point, the road manager can request the driver of the delivery vehicle 11 to travel through a route point that cannot be collected when delivery is performed as usual. For example, in a case where the delivery vehicle 11 performs periodic delivery to a determined delivery destination, it is possible to request travel of a route point where the delivery vehicle does not travel. In addition, the driver of the delivery vehicle 11 can confirm the displayed information and determine to collect the road information via the candidate planned route point in the middle of the delivery. Thus, the management system 100 can support collection of the road information of more points while achieving timely delivery.

According to one example embodiment, since the delivery vehicle 11 collects the road information on the candidate planned route point, it is possible to reduce the burden on the road manager to collect the road information. In addition, since the delivery vehicle 11 collects the road information while delivering, a fuel consumed can be reduced as compared with a case where the road manager causes the vehicle to travel only to collect the road information. Therefore, it is expected to reduce environmental load. A delivery company can contribute to an area managed by the road manager by providing the road information.

### Second Example Embodiment

Next, a management system 110 according to a second example embodiment will be described. In the description of the configuration of the second example embodiment, description of the same configuration as that of the management system 100 according to the first example embodiment will be omitted.

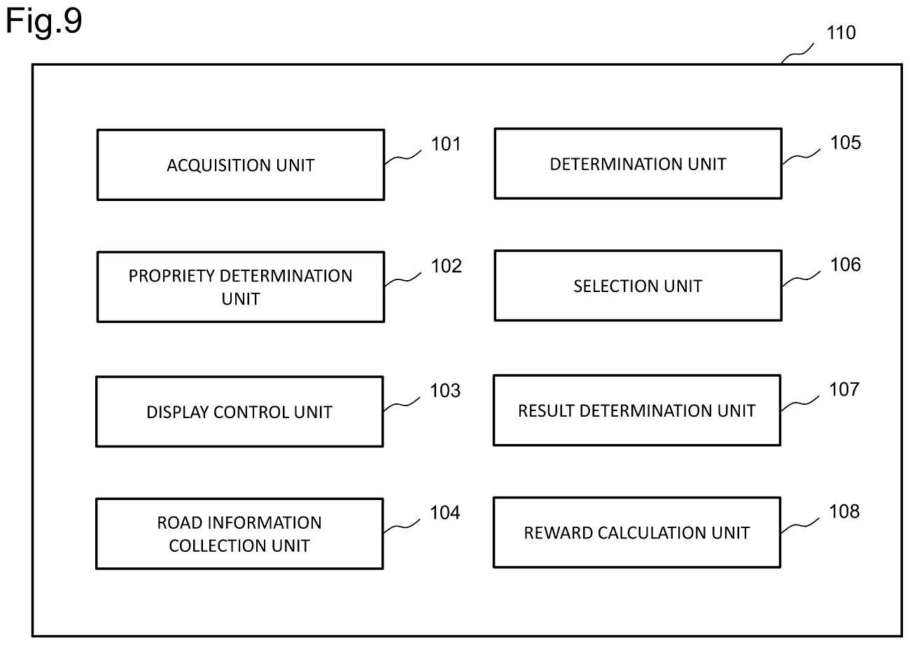

FIG. 9 is a block diagram illustrating a configuration example of the management system 110 according to the second example embodiment. The management system 110 according to the second example embodiment is different from that of the first example embodiment in including a road information collection unit 104, a determination unit 105, a selection unit 106, a result determination unit 107, and a reward calculation unit 108.

The road information collection unit 104 collects road information collected by a sensor 10. The road information collection unit 104 may collect the road information from a road information database 40. Alternatively, the road information collection unit 104 may collect the road information from the sensor 10. In this case, the management system 110 communicates with the sensor 10. The road information collection unit 104 may collect the road information of a candidate planned route point with reference to a position information associated with the road information.

The determination unit 105 determines the candidate planned route point. The candidate planned route point determined by the determination unit 105 may be stored in the road information database 40. The acquisition unit 101 acquires a position of the candidate planned route point determined by the determination unit 105. Then, a propriety determination unit 102 determines whether the determined candidate planned route point can be passed. Then, in the display control unit 103, the information regarding the candidate planned route point that can be passed is displayed.

For example, the determination unit 105 may refer to the road information database 40, detect a point having insufficient road information, and determine the detected point as the candidate planned route point. Further, the determination unit 105 may refer to a delivery management database 21 and determine a point that is not on a planned route to make the rounds to the delivery destination of a delivery vehicle 11 as the candidate planned route point. Furthermore, the determination unit 105 may determine a point having no or less travel history of the delivery vehicle 11 as the candidate planned route point.

Alternatively, the determination unit 105 may determine a point requiring intensive management as the candidate planned route point as follows. In an area with a large traffic volume, road surface deterioration progresses fast, and there is a possibility that intensive management is required. Therefore, the determination unit 105 may determine an area with a large traffic volume as the candidate planned route point. In an area where the traffic volume of vehicles and people is small, intensive management may be necessary for guarding against incidents and accidents. Therefore, the determination unit 105 may determine an area with a small traffic volume as the candidate planned route point. The determination unit 105 may determine an area in which there is a possibility that trees are extending toward the road as the candidate planned route point, considering that intensive management is necessary.

The determination unit 105 may determine a point with a small traffic volume as the candidate planned route point based on the traffic condition. This is because when the traffic volume is small, the road surface is not covered by other vehicles, and the state of the road surface is easily captured. Furthermore, when the traffic volume is small, the delivery vehicle 11 can quickly pass through the candidate planned route point and head for the next delivery destination. Therefore, it is assumed that an influence on the delivery destination is small even through the candidate planned route point.

The determination unit 105 may determine each of a point where the vehicle of the road manager travels and a point where the delivery vehicle 11 travels. Further, the determination unit 105 may determine the priority for each candidate planned route point. Furthermore, the determination unit 105 may determine an amount of reward for traveling through each candidate planned route point. For example, the higher the priority, the higher the reward determined by the determination unit 105.

The selection unit 106 selects the delivery vehicle 11 in charge of one of the delivery areas. Then, the propriety determination unit 102 determines whether the selected delivery vehicle 11 can pass through the candidate planned route point while delivering within the delivery time limit.

For example, the selection unit 106 selects the delivery vehicle 11 that is in charge of delivery in an area where the candidate planned route point exists or an area near the candidate planned route point. Further, the selection unit 106 may refer to the delivery management database 21 and select the delivery vehicle 11 with a few delivery destinations or the delivery vehicle 11 having a small total amount of packages to be delivered. Further, the selection unit 106 may select the delivery vehicle 11 traveling near the candidate planned route point based on the current position of the delivery vehicle 11. Furthermore, the selection unit 106 may select the delivery vehicle 11 that can deliver earlier than the delivery time limit or a predetermined scheduled delivery time based on the delivery status of the delivery vehicle 11.

The acquisition unit 101 acquires the delivery destination position of the selected delivery vehicle 11 and the delivery time limit. Alternatively, the acquisition unit 101 may acquire the delivery destinations and delivery time limits of the plurality of delivery vehicles 11 before the selection unit 106 selects the delivery vehicle 11. The selection unit 106 may select the delivery vehicle 11 based on the position of the delivery destination, the total amount of baggage, the current position, the delivery status, or the like acquired by the acquisition unit 101.

The result determination unit 107 determines that the delivery vehicle 11 has traveled through the candidate planned route point. For example, the result determination unit 107 may acquire the current position of the delivery vehicle 11 from the sensor 10 or a driver terminal 20, and determine that the delivery vehicle 11 has traveled through the candidate planned route point. The delivery management database 21 may store a history of the travel route of the delivery vehicle 11 transmitted from the sensor 10 or the driver terminal 20. In this case, the result determination unit 107 may determine whether the delivery vehicle 11 has traveled through the candidate planned route point based on the history of the travel route of the delivery vehicle 11 stored in the delivery management database 21. For example, when the history of the travel route indicates that the delivery vehicle 11 has traveled near the candidate planned route point, the result determination unit 107 determines that the delivery vehicle 11 has traveled through the candidate planned route point.

The result determination unit 107 may determine that the delivery vehicle 11 has traveled through the candidate planned route point when the road information collection unit 104 collects the road information of the candidate planned route point. Furthermore, the result determination unit 107 may refer to the road information database 40 and determine whether the road information associated to the position information of a candidate planned route point is stored.

The reward calculation unit 108 calculates a reward according to the candidate planned route point where it is determined that the delivery vehicle 11 has traveled. The reward calculation unit 108 outputs the calculated reward. The road manager arranges payment of the reward according to the output information. Alternatively, according to the output information, the delivery company requests the road manager to pay the reward. For example, the road manager pays the reward to the delivery company that manages the delivery vehicle 11. The road manager and the delivery company may pay the reward to the driver of the delivery vehicle 11.

The display control unit 103 may display a reward scheduled to be obtained by traveling at the displayed candidate planned route point as the information regarding the candidate planned route point. For example, the display control unit 103 may display the scheduled reward before the delivery vehicle 11 travels through the candidate planned route point. In addition, the display control unit 103 may display a reward associated to a track record of the candidate planned route point through which the delivery vehicle 11 has traveled.

The amount of reward may be calculated by the number of candidate planned route points through which the delivery vehicle has traveled. The amount of reward to be added may be different for each candidate planned route point. The amount of reward may be determined by the priority of the candidate planned route point. In this case, the display control unit 103 indicates the amount of reward for each candidate planned route point on the map, for example. The driver looks at the amount of reward and determines whether to travel through the candidate planned route point.

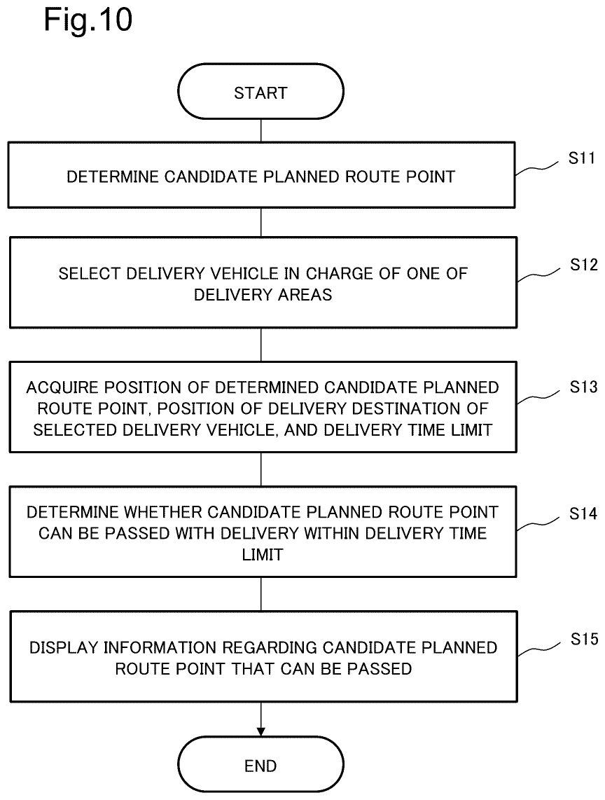

FIG. 10 is a flowchart illustrating an operation example of the management system 110 according to the second example embodiment.

For example, the management system 110 may start the processing of FIG. 10 in response to the operation of the driver terminal 20 before the driver of the delivery vehicle 11 starts delivery.

The determination unit 105 determines the candidate planned route point (step S11). The selection unit 106 selects the delivery vehicle 11 in charge of one of the delivery areas (step S12). The acquisition unit 101 acquires the position of the candidate planned route point determined by the determination unit 105. Furthermore, the acquisition unit 101 acquires the delivery destination position of the selected delivery vehicle 11 and the delivery time limit (step S13).

The propriety determination unit 102 determines whether the delivery vehicle 11 can pass through the candidate planned route point while delivering within the delivery time limit based on the position of the candidate planned route point, the position of the delivery destination, and the delivery time limit acquired by the acquisition unit 101 (step S14). The display control unit 103 causes the driver terminal 20 used by the driver of the delivery vehicle 11 to display information indicating the information regarding the candidate planned route point where it is predictively determined that the delivery vehicle 11 can pass (step S15).

Thus, the management system 110 ends the processing of FIG. 10.

According to one example embodiment, the result determination unit 107 determines that the delivery vehicle 11 has traveled through the candidate planned route point. Then, the reward calculation unit 108 calculates a reward according to the candidate planned route point through which the delivery vehicle 11 has traveled. Therefore, the road manager can use the calculation result to pay the delivery company the reward. It is possible to provide an advantage of collecting driving information via the candidate planned route point to the delivery company. Thus, the management system 110 can support collection of the road information of more points.

According to one example embodiment, the selection unit 106 selects the delivery vehicle 11. Therefore, when there are the plurality of delivery vehicles 11, it is possible to select the delivery vehicle that can efficiently collect the road information. Thus, the management system 110 can support efficient collection of the road information.

Since the propriety determination unit 102 determines whether the selected delivery vehicle 11 can pass through the candidate planned route point, the processing can be reduced as compared with the case where the determination is performed for all the delivery vehicles 11.

According to one example embodiment, the determination unit 105 determines the candidate planned route point, thereby making it possible to support collection of the road information for a point where the collection of the road information is desired.

### Modifications

Each of the above example embodiments may be modified and used. Modifications will be described below.

The management system 100 according to the first example embodiment may include at least one of the road information collection unit 104, the determination unit 105, and the selection unit 106. The management system 110 according to the second example embodiment may not include at least one of the road information collection unit 104, the determination unit 105, and the selection unit 106.

### Cooperation With Delivery Companies

There is a case where a plurality of delivery companies provides delivery services in the road management area managed by the road manager or in an area near the road management area. At this time, the management systems 100 and 110 acquire information from the delivery management database 21 of each of the plurality of delivery companies. Then, the management systems 100 and 110 cause the driver terminal 20 of each delivery company to display the information regarding the candidate planned route points. Each of the delivery vehicles 11 of the plurality of delivery companies travels through the candidate planned route point based on the displayed information. The sensor 10 mounted on each of the delivery vehicles 11 collects the road information.

In such a case, the propriety determination unit 102 may determine whether each of the plurality of delivery vehicles 11 can pass through the candidate planned route point while delivering within the delivery time limit. The display control unit 103 may display the information regarding the candidate planned route point such that overlapping of the candidate planned route points at which the information is displayed on the driver terminal 20 of each of the plurality of delivery vehicles 11 is reduced.

The determination unit 105 may acquire a delivery route through which a plurality of companies pass and determine a point where the number of times of passing is small as the candidate planned route point. Furthermore, the determination unit 105 may determine the candidate planned route point for each delivery company so as to reduce overlapping of the candidate planned route points for each delivery company.

In a case where there are the plurality of delivery vehicles 11 determined to be able to pass through the candidate planned route point while delivering within the delivery time limit, the selection unit 106 may select any of the delivery vehicles 11.

### Utilization of Road Information

The purpose of collecting the road information according to the present disclosure is not limited to road analysis by the road manager. A regional administrator may collect the road information for crime prevention and watching over a region. The regional administrator can confirm situations of an incident and an accident by viewing the road image stored in the road information database 40. The road image may be used to confirm whether a missing person has not passed. For such a purpose, instead of the regional administrator, the delivery company may cause the delivery vehicle 11 to travel and collect the road information.

### Collection of Road Information by Route Bus

The present disclosure is also applicable to road information collection by a vehicle that transports a person. The vehicle that transfers the person is, for example, a route bus, an express bus, a community bus, a share taxi, or a chartered bus. For example, in the case of the route bus, the delivery vehicle 11 is replaced with a route bus on which the sensor 10 is mounted. The acquisition unit 101 according to the management systems 100 and 110 acquires positions of a garage and a bus stop and an arrival time limit to the bus stop. The propriety determination unit 102 determines whether the bus can arrive at the bus stop by the arrival time limit when the bus has passed through the candidate planned route point. The display control unit 103 causes a terminal used by a driver of the route bus to display the information regarding the candidate planned route point that can be passed. According to such a modification, the management systems 100 and 110 can support collection of the road information by making a detour to the candidate planned route point while transporting a person on time.

### Hardware Configuration

In the above-described example embodiments, each component of the management system 100 represents a block of functional units. A part or all of each component of the management system 100 may be achieved by any combination of a computer 500 and the program.

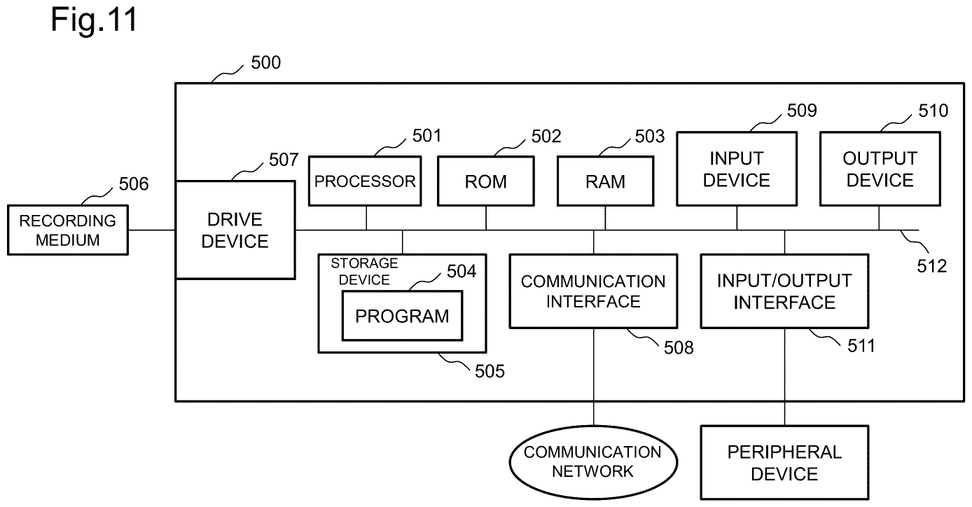

FIG. 11 is a block diagram illustrating an exemplary hardware configuration of the computer 500. Referring to FIG. 11, the computer 500 includes, for example, a processor 501, a read only memory (ROM) 502, a random access memory (RAM) 503, a program 504, a storage device 505, a drive device 507, a communication interface 508, an input device 509, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the management system 100. The program 504 is stored in advance in the ROM 502, the RAM 503, and the storage device 505. The processor 501 achieves each function of the management system 100 by executing instructions included in the program 504. The RAM 503 may store data to be processed in each function of the management system 100.

The drive device 507 reads and writes a recording medium 506. The communication interface 508 provides an interface with a communication network. The input device 509 is, for example, a mouse, a keyboard, or the like, and receives an input of information from an administrator or the like of the management system 100. The output device 510 is, for example, a display, and outputs (displays) information to the administrator or the like. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 11 is an example, and other components may be added or some components may not be included.

There are various modifications of the implementation method of the management system 100. For example, the management system 100 may be achieved by any combination of a computer and a program different for each component. A plurality of components included in the management system 100 may be achieved by any combination of one computer and a program.

At least a part of the management system 100 may be provided in a Saas (Software as a Service) format. That is, at least a part of the functions for achieving the management system 100 may be executed by software executed via a network.

While the present disclosure has been particularly illustrated and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

### REFERENCE SIGNS LIST

10 sensor
11 delivery vehicle
20 driver terminal
21 delivery management database
30 communication network
40 road information database
50 road manager terminal
100, 110 management system
101 acquisition unit
102 propriety determination unit
103 display control unit
104 road information collection unit
105 determination unit
106 selection unit
107 result determination unit
108 reward calculation unit

What is claimed is:

1. A management system comprising:
at least one memory storing instructions; and
at least one processor configured to execute the instructions to:
acquire a position of a candidate planned route point for collecting road information, a position of a delivery destination of a delivery vehicle on which a sensor that collects the road information is mounted, and a delivery time limit to the delivery destination;
determine whether the delivery vehicle passes through the candidate planned route point while delivering within the delivery time limit based on the position of the candidate planned route point, the position of the delivery destination, and the delivery time limit; and
display on a terminal used by a driver of the delivery vehicle to display information regarding the candidate planned route point where it is determined that the delivery vehicle passes.

2. The management system according to claim 1, wherein the at least one processor is further configured to execute the instructions to:
determine whether the delivery vehicle passes through the candidate planned route point while delivering within the delivery time limit based on a current delivery status of the delivery vehicle.

3. The management system according to claim 1, wherein the at least one processor is further configured to execute the instructions to:
determine that the delivery vehicle has traveled through the candidate planned route point; and
calculate a reward according to the candidate planned route point where it is determined that the delivery vehicle has traveled.

4. The management system according to claim 3, wherein the at least one processor is further configured to execute the instructions to:
display a reward scheduled to be obtained by traveling at the displayed candidate planned route point before the delivery vehicle travels through the candidate planned route point.

5. The management system according to claim 1, wherein the at least one processor is further configured to execute the instructions to:
display a scheduled delivery time to the delivery destination when the candidate planned route point is passed.

6. The management system according to claim 1, wherein the at least one processor is further configured to execute the instructions to:
display a route that passes through the candidate planned route point and the delivery destination and is in time for the delivery time limit.

7. The management system according to claim 1, wherein the at least one processor is further configured to execute the instructions to:
select, from a plurality of the delivery vehicles, the delivery vehicle that is in charge of delivery in an area where the candidate planned route point exists or an area near the candidate planned route point,
determine whether the selected delivery vehicle passes through the candidate planned route point while delivering within the delivery time limit.

8. The management system according to claim 1, wherein the at least one processor is further configured to execute the instructions to:
determine a point that is not on a planned route to make the rounds to the delivery destination as the candidate planned route point.

9. A management method performed by a computer comprising:
acquiring a position of a candidate planned route point for collecting road information, a position of a delivery destination of a delivery vehicle on which a sensor that collects the road information is mounted, and a delivery time limit to the delivery destination;
determining whether the delivery vehicle passes through the candidate planned route point while delivering within the delivery time limit based on the position of the candidate planned route point, the position of the delivery destination, and the delivery time limit; and
causing a terminal used by a driver of the delivery vehicle to display information regarding the candidate planned route point where it is determined that the delivery vehicle passes.

10. A non-transitory recording medium non-temporarily recording a program for causing a computer to execute a process, comprising:
acquiring a position of a candidate planned route point for collecting road information, a position of a delivery destination of a delivery vehicle on which a sensor that collects the road information is mounted, and a delivery time limit to the delivery destination;
determining whether the delivery vehicle passes through the candidate planned route point while delivering within the delivery time limit based on the position of the candidate planned route point, the position of the delivery destination, and the delivery time limit; and
causing a terminal used by a driver of the delivery vehicle to display information regarding the candidate planned route point where it is determined that the delivery vehicle passes.
